(19) United States
(12) Patent Application Publication
(10) Pub. No.: US 2024/0158251 A1
(43) Pub. Date: May 16, 2024

(54) CERIUM OXIDE PARTICLES, MAKING PROCESS THEREOF AND USE THEREOF IN CHEMICAL MECHANICAL POLISHING

(71) Applicant: RHODIA OPERATIONS, Lyon (FR)

(72) Inventors: Marie Plissonneau, Lyon (FR); Réka Toth, Saint-Genis-Laval (FR); Lauriane D'Alencon, Issy-Les-Moulineaux (FR); Valérie Buissette, Paris (FR); Mickaël Boudot, Antony (FR)

(73) Assignee: RHODIA OPERATIONS, Lyon (FR)

(21) Appl. No.: 18/550,272

(22) PCT Filed: Mar. 10, 2022
(86) PCT No.: PCT/EP2022/056266

§ 371 Date: Sep. 12, 2023

(30) Foreign Application Priority Data
Mar. 12, 2021 (EP) 21162231.1

(51) Int. Cl. C01F 17/235; C01F 1/00; C09G 1/02

(52) U.S. Cl. CPC C01F 17/235; C01F 1/00; C09G 1/02; C01P 2004/04; C01P 2004/51; C01P 2004/62; C01P 2006/12

(57) ABSTRACT

The invention relates to cerium oxide particles having a roughness index RI of at least 5, to a making process thereof and to the use thereof in chemical mechanical polishing applications.

### TECHNICAL FIELD

The present invention relates to cerium oxide particles and their use as a component of a composition for polishing, in particular a chemical mechanical polishing (CMP) composition. The present invention also relates to the method of preparation of the cerium oxide particles.

More specifically, the invention provides cerium oxide particles, which have good abrasive properties when implemented in a CMP composition, as well a method of preparation of such particles that is simple, economical and easy to implement at industrial scale.

### BACKGROUND ART

Ceric oxides are commonly used for polishing applications. The development of the electronics industry requires an increasingly considerable use of compositions for polishing various parts such as discs or dielectric compounds.

These compositions, which are usually commercialized in the form of dispersions, must exhibit a certain number of characteristics. For example, they must offer a high degree of removal of material, which reflects their abrasive capacity. They must also have a defectuosity which is as low as possible; the term “defectuosity” is intended to mean in particular the amount of scratches exhibited by the substrate once treated with the composition. For reasons of stability and of ease of use, these dispersions usually comprise particles of submicronic dimensions, i.e. generally less than 300 nm. In addition, the presence of particles that are too fine in these dispersions reduces their abrasive capacities, and particles that are too large can contribute to an increase in the defectuosity.

Thus, several types of cerium oxide particles specifically elaborated for CMP applications are known from the state of the art.

WO 2015/197656 discloses metal doped cerium oxide particles.

WO 08043703 discloses a suspension of cerium oxide particles in a liquid phase, said particles being secondary particles having an average size of at most 200 nm, and said secondary particles comprising primary particles whose average size is at most 100 nm with a standard deviation of at most 30% of the value of said average size of said primary particles.

WO 2015/091495 discloses a suspension of cerium oxide particles in a liquid phase, in which said particles comprise secondary particles comprising primary particles, wherein said secondary particles have an average size D50 comprised between 105 and 1000 nm, with a standard deviation comprised between 10 and 50% of the value of said average size of said secondary particles; and said primary particles have an average size D50 comprised between 100 and 300 nm, with a standard deviation comprised between 10 and 30% of the value of said average size of said primary particles.

We believe that there is still room for improvement for providing new cerium oxide particles exhibiting improved performances in CMP as well as a method of preparation of such particles that is simple, economical and easy to implement at industrial scale.

### BRIEF DESCRIPTION OF THE INVENTION

The Applicant elaborated new cerium oxide particles that could solve the above-mentioned problems.

One subject matter of the invention is thus cerium oxide particles, which exhibit a roughness index (RI) of at least 5, in particular ranging from 5 to 20, in particular ranging from 6 to 17. More particularly, the roughness index of the particles is defined by the following formula:

$$RI = \frac{TEM size}{SSA size}$$

wherein “TEM size” denotes the average size of the particles measured on transmission electron microscopy (TEM) images. Preferably, to get this average size, at least 80 particles are measured on transmission electron microscopy images.

“SSA size” denotes the theoretical average size of the particles determined from their BET (Brunauer, Emmett and Teller) specific surface area. More particularly, it can be calculated according to the following formula:

$$SSA size = \frac{6}{SSA \times ρ}$$

wherein SSA denotes the BET specific surface area of the particles and p denotes the density of cerium(IV) oxide and is equal to 7.22 g/cm³. More particularly, the BET specific surface area may be determined by nitrogen adsorption.

To the best of the inventors' knowledge, the roughness index achieved by the particles of the present invention is higher than the one of the cerium oxide particles of the state or the art. It is believed that it contributes to achieve a greater efficiency of polishing when such particles are used as abrasive particles in a CMP composition or process.

The invention also relates to a process for producing the cerium oxide particles of the invention, comprising at least the following steps:
(a) contacting, under an inert atmosphere, (i) an aqueous solution of a base, (ii) an aqueous solution comprising NO₃⁻, Ce^{III}, optionally Ce^{IV}, and (iii) an organic acid or a salt thereof to obtain a mixture, wherein the organic acid is a substituted or unsubstituted, C1-C20 -alkyl, -alkenyl or -alkynyl carboxylic acid;
(b) subjecting the mixture obtained in step (a) to a thermal treatment;
(c) optionally acidifying the mixture obtained in step (b);
(d) optionally washing with water the solid material obtained at the end of step (b) or (c);
(e) optionally subjecting the solid material obtained at the end of step (d) to a mechanical treatment to deagglomerate the particles.

Advantageously, this process enables to prepare in a simple manner the cerium oxide particles of the invention.

The invention also relates to the cerium oxide particles obtainable or obtained by the above mentioned process, to a dispersion of the cerium oxide particles of the invention in a liquid medium, to the use of said dispersion or of the particles of the invention to prepare a CMP composition, to the CMP composition comprising said dispersion or said particles, to a polishing process wherein said CMP composition is used to remove a portion of the substrate and to the semiconductor comprising the substrate polished thereby.

### BRIEF DESCRIPTION OF THE FIGURE(S)

FIGS. 1 and 4 are images of the particles of the invention observed by transmission electron microscopy.

FIG. 5 is an image of cerium oxide particles of the state of the art observed by transmission electron microscopy.

The pictures were obtained with a JEM-1400 (JEOL) apparatus operating at 120 kV.

### DESCRIPTION OF THE INVENTION

In the present disclosure, the expression “comprised between . . . and . . .” or the like should be understood as including the limits.

The term “cerium oxide” in connection with the particles of the invention means cerium(IV) oxide also known as ceric oxide. Cerium oxide generally has a purity degree of at least 99.8% by weight with respect to the weight of the oxide. Cerium oxide is generally crystalline ceric oxide. Some impurities, other than cerium, may be present in the oxide. The impurities may stem from the raw materials or starting materials used in the process of preparation of the cerium oxide. The total proportion of the impurities is generally lower than 0.2% by weight with respect to the cerium oxide. Residual nitrates are not considered as impurities in this application.

The expression “dispersion” in connection with dispersions of cerium oxide particles of the invention denotes a system consisting of solid fine cerium oxide particles of submicronic dimensions, stably dispersed in a liquid medium, it being possible for said particles to also optionally contain residual amounts of bound or adsorbed ions such as, for example, nitrates or ammoniums.

The invention will now be described in more details according to different embodiments thereof.

As explained earlier, one subject matter of the invention is cerium oxide particles which exhibit a roughness index (RI) of at least 5. More particularly, the roughness index of the particles of the invention may range from 5 to 20, in particular from 6 to 17, more particularly from 7 to 14.

The roughness index (RI) of the particles is defined by the following formula:

$$RI = \frac{TEM size}{SSA size}$$

wherein “TEM size” denotes the average size of the particles measured on transmission electron microscopy images, and “SSA size” denotes the theoretical average size of the particles determined from their BET (Brunauer, Emmett and Teller) specific surface area. In particular, the SSA size can be calculated from to the following formula:

$$SSA size = \frac{6}{SSA \times ρ}$$

wherein SSA denotes the BET specific surface area of the particles and p denotes the density of cerium(IV) oxide and is equal to 7.22 g/cm³. In particular, the SSA size can be determined by nitrogen adsorption.

The TEM size is the effective average size of the particles. It is preferably measured on a high number of particles, for example at least 80, preferably at least 90, more preferably at least 100, to get a statistical analysis. The measurement is usually done on one or more pictures of the same sample of the cerium oxide particles. The particles retained are preferably such that their images are well visible on the picture(s). According to one embodiment, which will be detailed later on, the number of particles which are spheroidal in shape corresponds preferably to at least 80.0%, more particularly at least 90.0%, even more particularly at least 95.0% of the particles.

The specific surface area (SSA) may be determined on a powder of the cerium oxide particles by adsorption of nitrogen by the Brunauer-Emmett-Teller method (BET method). The method is disclosed in standard ASTM D 3663-03 (reapproved 2015). The method is also described in the periodical “The Journal of the American Chemical Society, 60, 309 (1938)”. The specific surface area may be determined automatically with an appliance TriStar 3000 of Micromeritics according to the guidelines of the constructor. Prior to the measurement, the samples in the form of powders shall be degassed under static air by heating at a temperature of at most 210° C. to remove the adsorbed species.

The determination of the BET specific surface area enables to calculate the SSA size according to the formula given above: for a given SSA, the formula gives a theoretical size of the cerium(IV) oxide particles, assuming that the particles are spherical. The ratio TEM size/SSA size, is therefore an indicator of the roughness of the particles: the higher is this ratio, the higher is the roughness of the particles. It is believed that cerium oxide particles having an increased roughness index have an enhanced efficiency when they are used in a polishing process such as CMP.

According to one preferred embodiment, the cerium oxide particles of the invention are spheroidal in shape. To the best of the inventors' knowledge, the combination of the specific roughness index of the particles and of their specific spheroidal morphology contributes to achieve enhanced results in CMP therewith compared to conventional cerium oxide particles (i.e. being not spheroidal and not exhibiting the required roughness index).

The cerium oxide particles being spheroidal in shape of the invention may exhibit a sphericity ratio SR between 0.8 and 1.0, more particularly between 0.85 and 1.0, even more particularly between 0.90 and 1.0. SR may preferably be between 0.90 and 1.0 or between 0.95 and 1.0. The sphericity ratio of a particle is calculated from the measured perimeter P and area A of the projection of the particle using the following equation:

$$SR = 4 π \frac{A}{{P}^{2}}$$

For an ideal sphere, SR is 1.0 and it is below 1.0 for spheroidal particles.

The sphericity ratio is usually determined by a Dynamic Image Analysis (DIA). An example of appliance that can be used to perform the DIA is the CAMSIZER®P4 of Retsch or the QicPic® of Sympatec. The sphericity ratio may be more particularly measured according to ISO 13322-2 (2006). The DIA generally requires the analysis of a large number of particles to be statistically meaningful (e.g. at least 80).

According to one embodiment, the cerium oxide particles of the invention may exhibit an average size which is greater than or equal to 30 nm. Often, the particle size is greater or equal to 70 nm. The cerium oxide particles of the invention may exhibit an average size which is lower than or equal to 500 nm. Often, the particle size is lower than or equal to 300 nm, particularly lower than or equal to 150 nm. In one aspect the cerium oxide particles of the invention may exhibit an average size which is comprised between 140 and 300 nm, in particular between 145 and 270 nm, more particularly between 150 and 250 nm, even more particularly between 155 and 240 nm. The average size is preferably measured from TEM images. The measurement is preferably made on at least 80 particles.

According to one embodiment, the cerium oxide particles of the invention may exhibit a specific surface area comprised between 30 and 100 m2/g, more particularly between 32 and 80 m2/g, more particularly between 35 and 70 m2/g, even more particularly between 36 and 60 m2/g. The specific surface area is determined on a powder by adsorption of nitrogen by the Brunauer-Emmett-Teller method (BET method), as explained earlier.

In a particular aspect, the specific surface area is from 15 to 100 m2/g, more particularly between 20 and 40 m2/g,

In another aspect, the invention concerns cerium oxide particles characterized in that said particles are spheroidal, exhibit a roughness index RI of at least 2, particularly of at least 3.5 wherein RI is defined by the formula:

$$RI = \frac{TEM size}{SSA size}$$

wherein “TEM size” denotes the average size of the particles measured on transmission electron microscopy images and “ SSA size” denotes the theoretical average size of the particles according to the following formula:

$$SSA size = \frac{6}{SSA \times ρ}$$

wherein SSA denotes the BET specific surface area of the particles determined by nitrogen adsorption and ρ denotes the density of cerium(IV) oxide and is equal to 7.22 g/cm3 and in that said particles exhibit a carbon weight ratio ranging from 0.001 wt % to 5 wt %, in particular from 0.1 wt % to 2.5 wt %.

In a particular embodiment, the roughness index RI in this aspect is lower than 5.

To the best of the inventors' knowledge, the carbon weight ratio in the cerium oxide particles according to this aspect contributes to the compatibility of the cerium oxide particles with other components of dispersions and polishing compositions commonly used for CMP applications.

The characterisation of the spheroidal shape, the particle size and the specific surface area in this aspect are as described above.

According to one embodiment, the cerium oxide particles of the invention may exhibit a carbon weight ratio ranging from 0.001 wt % to 5 wt %, in particular from 0.1 wt % to 2.5 wt %. The carbon traces may be a footprint of the synthesis method employed to prepare the particles, which requires a specific organic acid. The dosage of the elemental carbon may be performed by using a carbon and sulfur analyzer, such as a Horiba EMIA 320-V2.

The invention also relates to a process for producing the cerium oxide particles of the invention, comprising at least the following steps:
(a) contacting, under an inert atmosphere, (i) an aqueous solution of a base, (ii) an aqueous solution comprising NO₃⁻, Ce^{III}, optionally Ce^{IV}, and (iii) an organic acid or a salt thereof to obtain a mixture, wherein the organic acid is a substituted or unsubstituted, C1-C20 -alkyl, -alkenyl or -alkynyl carboxylic acid;
(b) subjecting the mixture obtained in step (a) to a thermal treatment;
(c) optionally acidifying the mixture obtained in step (b);
(d) optionally washing with water the solid material obtained at the end of step (b) or (c);
(e) optionally subjecting the solid material obtained at the end of step (d) to a mechanical treatment to deagglomerate the particles.

It is advantageous to use salts and ingredients of a high purity. The purity of the salts may be at least 99.5 wt %, more particularly of at least 99.9 wt %.

An aqueous solution of a base (i) is used in step (a). Products of the hydroxide type can in particular be used as base. Mention may be made of alkali metal or alkaline earth metal hydroxides and aqueous ammonia. Secondary, tertiary or quaternary amines can also be used. The aqueous solution of the base can also be degassed beforehand by bubbling with an inert gas.

The amount of the base used in step (a), expressed by the molar ratio base/total Ce, is preferably comprised between 4 and 10, preferably between 5 and 8.

An aqueous solution (ii) comprising NO₃⁻, Ce^{III}, and optionally Ce^{IV}, is used in step (a). Nitrates or cerium can in particular be used to prepare the solution. If Ce^{IV} is to be present in the aqueous solution, the Ce^{IV}/total Ce molar ratio is preferably comprised between 1/500000 and 1/4000. This molar ratio may especially be between 1/6000 and 1/4000. The Ce^{IV}/total Ce molar ratio used in the examples may be used.

An aqueous ceric nitrate solution obtained by the reaction of nitric acid with an hydrated ceric oxide may be used in the method of preparation. The ceric oxide is prepared conventionally by reaction of a solution of a cerous salt and of an aqueous ammonia solution in the presence of aqueous hydrogen peroxide to convert Ce^{III} cations into Ce^{III} cations. It is also particularly advantageous to use a ceric nitrate solution obtained according to the method of electrolytic oxidation of a cerous nitrate solution as disclosed in FR 2570087. A solution of ceric nitrate obtained according to the teaching of FR 2570087 may exhibit an acidity of around 0.6 N.

Ce^{IV} if present in step (a) may be provided by a salt, which may be cerium IV nitrate or cerium ammonium nitrate.

The amount of nitrate ions in the aqueous solution used in step (a), expressed by the NO₃⁻/Ce^{III} molar ratio is generally between 1/3 and 5/1. The acidity of the aqueous solution used in step (a) is preferably comprised between 0.8 N and 12.0 N.

A specific organic acid (iii), being a substituted or unsubstituted, C1-C20 -alkyl, -alkenyl or -alkynyl carboxylic acid, or a salt thereof, is used in step (a). The length of the chain of the -alkyl, -alkenyl or -alkynyl group may be more particularly in C1-C12, C1-C6 or even in C1-C3. The organic acid is preferably an -alkyl or -alkenyl carboxylic acid, more preferably an -alkyl carboxylic acid.

According to one embodiment, the organic acid is substituted. Examples of substituents include halogen, lower alkyl (i.e. alkyl groups with fewer than six carbon atoms), aryl, alkoxy, hydroxyl, amino, alkylamino, arylamino, alkylsulfinyl, alkylsulfonyl, arylsulfinyl and arylsulfonyl. Preferred substituents are lower alkyl groups, and more particularly C1-C3 alkyl groups, especially methyl groups. One or more substituents may be present in the -alkyl, -alkenyl or -alkynyl group, in particular one or more C1-C3 alkyl groups, especially one or more methyl groups. Preferably, the organic acid is a C1-C6 alkyl carboxylic acid which is substituted by at least one C1-C3 alkyl group, more preferably a C1-C3 alkyl carboxylic acid which is substituted by at least one C1-C2 alkyl group, more preferably a C1-C3 alkyl carboxylic acid which is substituted by at least one methyl group, being even more preferably pivalic acid.

According to another alternative embodiment, the organic acid is unsubstitued. In this case, the organic acid is preferably an unsubstitued C1-C20 alkyl carboxylic acid, more preferably an unsubstitued C1-C12 alkyl carboxylic acid, more preferably an unsubstitued C1-C6 alkyl carboxylic acid, more preferably an unsubstitued C1-C3 alkyl carboxylic acid, even more preferably propionic acid.

In yet another embodiment, the organic acid is a dicarboxylic acid, for example a C2-C8 dicarboxylic acid such as malonic acid, succinic acid and, preferably adipic acid. The dicarboxylic acid can be substituted or, in particular, unsubstituted, as described here above.

As suitable salts of the above organic acids, mentioned can be made of ammonium salts.

According to one embodiment, the organic acid is in the form of an aqueous solution. The concentration of the organic acid in aqueous solution may range for example from 1 to 20 wt %, in particular from 2 to 10 wt %, more particularly from 3 to 7 wt %. According to another embodiment, the organic acid is used pure i.e. not diluted.

The ingredients (i), (ii) and (iii) which are contacted in step (a) to form a mixture can be contacted in any order. According to one embodiment especially, the aqueous solution of the base (i) and the organic acid (iii) are contacted with each other and the resulting mixture is contacted with the aqueous solution (ii) containing the cerium nitrate(s). In such case, the organic acid (iii) can be used pure (i.e. not diluted) as the solution of the base (i) is already in the form of an aqueous solution. The contacting of the mixture of (i) and (iii) with (ii) may consist in adding (ii) to said mixture, preferably under agitation and/or inert gas bubbling.

According to an alternative embodiment, the aqueous solution (ii) containing the cerium nitrate(s) and the aqueous solution of the base (i) are contacted with each other and the resulting mixture is contacted with the organic acid (iii). In such case, the organic acid (iii) can be used in the form of an aqueous solution thereof. The contacting of (ii) and (i) may consist in adding (ii) to (i), preferably under agitation and/or inert gas bubbling.

The organic acid (iii) may be used at a concentration ranging from 1 to 245 mmol/L relatively to the total volume of the mixture obtained in step (a), in particular from 2 to 150 mmol/L, more particularly from 5 to 100 mmol/L, more particularly from 5 to 50 mmol/L. This range is particularly suitable to form well-defined particles.

The amount of free oxygen in the mixture should be carefully controlled and minimized. To this end, one or more of the ingredients used (i), (ii) and (iii) and/or the resulting mixture may be degassed by bubbling with an inert gas. The term “inert gas” or “inert atmosphere” is intended to mean an atmosphere or a gas free of oxygen, it being possible for the gas to be, for example, nitrogen or argon.

Step (a) consists in reacting the ingredient (i), (ii) and (iii). Step (a) is preferably carried out under an inert atmosphere, notably either in a closed reactor or in a semi-closed reactor with sweeping with the inert gas. The bringing into contact is generally carried out in a stirred reactor.

Step (a) is generally carried out at a temperature comprised between 5° C. and 50° C. This temperature may be 20-25° C.

Step (b) is a thermal treatment of the reaction medium obtained at the end of the preceding step. It may consist in (i) a heating substep and (ii) in an aging substep.

The heating substep (i) may consist in heating the medium at a temperature that is generally comprised between 75° C. and 95° C., more particularly between 80° C. and 90° C.

The aging substep (ii) may consist in maintaining the medium at a temperature comprised between 75° C. and 95° C., more particularly between 80° C. and 90° C. The duration of the aging substep (ii) is between 2 hours to 20 hours. As a rule of thumb, the higher the temperature of the aging step, the lower the duration of the aging substep. For instance, when the temperature of the aging substep is between 85° C. and 90° C., eg. 88° C., the duration of the aging substep may be between 2 hours and 15 hours, more particularly between 4 hours and 15 hours. When the temperature of the aging substep is between 75° C. and 85° C., eg. 80° C., the duration of the aging substep may be between 15 hours and 30 hours.

During step (b), the oxidation of Ce^{III} to Ce^{IV} occurs. This step may also be carried out under an inert atmosphere, the description with respect to this atmosphere for step (a) being applied similarly here. Similarly the thermal treatment may be carried out in a stirred reactor.

In step (c), the mixture obtained at the end of step (b) may optionally be acidified. This step (c) may be performed by using nitric acid. The reaction mixture may be acidified by HNO₃ to a pH lower than 3.0, more particularly comprised between 1.5 and 2.5.

In step (d), the solid material obtained at the end of step (b) or step (c) is washed with water, preferably deionized water. This operation makes it possible to decrease the amount of residual nitrates in the dispersion and to obtain the targeted conductivity. This step may be carried out by filtering the solid from the mixture and redispersing the solid in water. Filtration and redispersion may be performed several times if necessary.

In step (e), the solid material obtained at the end of step (d) may be subjected to a mechanical treatment to deagglomerate the particles. The step may be carried out by a double jet treatment or ultrasonic deagglomeration. This step usually leads to a sharp particle size distribution and to a reduction of the number of large agglomerated particles. According to an embodiment, the cerium oxide particles have been subjected to the mechanical treatment of deagglomeration. According to another embodiment, the cerium oxide particles have not been subjected to the mechanical treatment of deagglomeration.

After step (e), the solid material may be dried to obtain the cerium oxide particles in the powder form. After step (e), water or a mixture of water and of a miscible liquid organic compound may also be added to obtain a dispersion of the cerium oxide particles in a liquid medium.

One further object of the invention is the cerium oxide particles obtainable or obtained by the above-depicted process.

The invention also relates to a dispersion of the cerium oxide particles in a liquid medium. The dispersion comprises the cerium oxide particles of the invention and a liquid medium. The liquid medium may be water or a mixture of water and of a water-miscible organic liquid. The water-miscible organic liquid should not make the particles precipitate or agglomerate. The water-miscible organic liquid may for instance be an alcohol like isopropyl alcohol, ethanol, 1-propanol, methanol, 1-hexanol; a ketone like acetone, diacetone alcohol, methyl ethyl ketone; an ester like ethyl formate, propyl formate, ethyl acetate, methyl acetate, methyl lactate, butyl lactate, ethyl lactate. The proportion water/organic liquid may be between 80/20 to 99/1 (wt/wt).

The proportion of cerium oxide particles in the dispersion may be comprised between 1.0 wt % and 40.0 wt %, this proportion being expressed as the weight of the cerium oxide particles over the total weight of the dispersion. This proportion may be comprised between 10.0 wt % and 35.0 wt %.

The dispersion may also exhibit a conductivity lower than 300μS/cm, more particularly lower than 150 μS/cm, even more particularly lower than 100 μS/cm or 50 μS/cm. The conductivity is measured with a conductimeter 9382-10D of HORIBA, Ltd.

The cerium oxide particles of the invention or the dispersion of the invention may be used to prepare a polishing composition, more particularly a CMP composition. They are used as a component of a polishing composition, more particularly a CMP composition.

The invention also relates to a CMP composition. A CMP composition (or chemical-mechanical polishing composition) is a polishing composition used for the selective removal of material from the surface of a substrate. It is used in the field of integrated circuits and other electronic devices. Indeed, in the fabrication of integrated circuits and other electronic devices, multiple layers of conducting, semiconducting, and dielectric materials are deposited onto or removed from the surface of a substrate. As layers of materials are sequentially deposited onto and removed from the substrate, the uppermost surface of the substrate may become non-planar and require planarization. Planarizing a surface (or “polishing”) the surface, is a process where material is removed from the surface of the substrate to form a generally even, planar surface. Planarization is useful in removing undesired surface topography and surface defects, such as rough surfaces, agglomerated materials, crystal lattice damage, scratches, and contaminated layers or materials. Planarization also is useful in forming features on a substrate by removing excess deposited material used to fill the features and to provide an even surface for subsequent levels of metallization and processing.

The substrate that can be polished with a polishing composition or a CMP composition may be for instance a silicon dioxide-type substrates, glass, a semi-conductor or a wafer.

The particles of the invention or the dispersion of the invention may be used to prepare a CMP composition. The invention thus also relate to a CMP composition comprising the cerium oxide particles or the dispersion such as defined above.

The polishing composition or the CMP composition usually contains different ingredients other than the cerium oxide particles. The polishing composition may comprise one or more of the following ingredients:
abrasive particles other than the cerium oxide particles or of the dispersion of the present invention; and/or
a pH regulator; and/or
a surfactant; and/or
a rheological control agent, including viscosity enhancing agents and coagulants; and/or
an additive selected from a non-ionic polymer, a cationic polymer, an anionic polymer, a quaternary ammonium, a silane, a sulfonated monomer, a phosphonated monomer, an acrylate, a starch, a cyclodesxtrin and combinations thereof.

The pH of the polishing composition is generally between 1 to 6. Typically, the polishing composition has a pH of 3.0 or greater. Also, the pH of the polishing composition typically is 6.0 or less.

The invention also relates to a method for removing a portion of a substrate, comprising polishing the substrate with a polishing composition such as described above.

The invention finally relates to a semiconductor polished by this method. Should the disclosure of any patents, patent applications, and publications which are incorporated herein by reference conflict with the description of the present application to the extent that it may render a term unclear, the present description shall take precedence.

The invention will now be further described in examples without intending to limit it.

### EXAMPLES

### Example 1

A cerium nitrate solution was prepared by mixing 111.3 g of 2.87 M trivalent cerium nitrate, 16.82 g of 68% HNO3 and 3.26 g of deionized water. This solution was put into 250 mL semi-closed vessel. Subsequently cerium nitrate (IV) equivalent with 1/5000 of cerium IV/total cerium molar ratio was added to the cerium nitrate solution. The ammonia aqueous solution was prepared by mixing 74.55 g of 13.35 M ammonia water, 623.03 g of deionized water. This solution was put into 1 L semi-closed reactor jacketed, and bubbled by N2 gas at the flow of 210 L/h under agitation for 1 hour. The above described cerium nitrate solution was added to the ammonia aqueous solution in approximately 30 min in the same conditions of agitation and N2 bubbling. The organic acid solution was prepared by adding 0.90 g of pivalic acid to 20 g of deionized water, bubbled by N2 gas for 1 hour and then added to the reactor .The temperature of reaction mixture was heated up to 85° C. in approximately 1 hour and maintained for approximately 4 hours at the same conditions of agitation with reduced N2 bubbling flow (below 10 L/h). The reaction mixture was cooled down and acidified at pH 2 with 68% HNO3. After decantation, the supernatant was removed and NH4OH was added to the slurry to reach pH 8.

The reaction mixture was washed with deionized water thanks to centrifugation. The washing was repeated when the conductivity of washing solution was less 0.04 mS/cm.

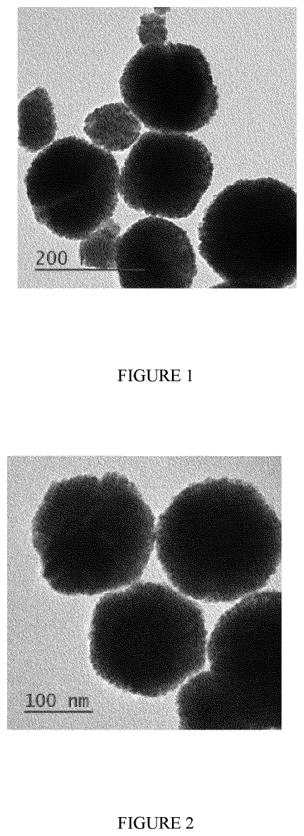

The BET specific surface area determined by nitrogen adsorption was 37.9 m2/g. The suspension was observed by TEM, for approximately 80 particles representative of the suspension, each of particles were counted and measured. The average particle size was 193 nm and standard deviation was 39 nm corresponding to 20% of average particle size. The SSA size, determined as explained in the present specification, is equal to 22, giving a roughness index RI, determined as explained in the present specification, of 8.8. The percentage of Carbon is determined as % C=0.4 wt %. TEM picture of the spheroidal rough particles obtained is reported in FIG. 1.

### Example 2

A cerium nitrate solution was prepared by mixing 111.3 g of 2.87 M trivalent cerium nitrate, 16.81 g of 68% HNO3 and 3.25 g of deionized water. This solution was put into 250 mL semi-closed vessel. Subsequently cerium nitrate (IV) equivalent with 1/5000 of cerium IV/total cerium molar ratio was added to the cerium nitrate solution. The ammonia aqueous solution was prepared by mixing 74.20 g of 13.35 M ammonia water, 643.50 g of deionized water and 0.92 g of pivalic acid. This solution was put into 1 L semi-closed reactor jacketed, and bubbled by N2 gas at the flow of 210 L/h under agitation for 1 hour. The above described cerium nitrate solution was added to the ammonia aqueous solution in approximately 30 min in the same conditions of agitation and N2 bubbling. The temperature of reaction mixture was heated up to 85° C. in approximately 1 hours and maintained for approximately 4 hours at the same conditions of agitation with reduced N2 bubbling flow (below 10 L/h). The reaction mixture was cooled down and acidified at pH 2 with 68% HNO3. After decantation, the supernatant was removed and NH4OH was added to the slurry to reach pH 8.

The reaction mixture was washed with deionized water thanks to centrifugation. The washing was repeated when the conductivity of washing solution was less 0.04 mS/cm.

The BET specific surface area determined by nitrogen adsorption was 44.8 m2/g. The suspension was observed by TEM, for approximately 80 particles representative of the suspension, each of particles were counted and measured. The average particle size was 165 nm and standard deviation was 50 nm corresponding to 30% of average particle size. The SSA size, determined as explained in the present specification, is equal to 19, giving a roughness index RI, determined as explained in the present specification, of 8.9. The percentage of Carbon is determined as % C=0.37 wt % TEM picture of the spheroidal rough particles obtained is reported in FIG. 2.

### Example 3

A cerium nitrate solution was prepared by mixing 222.4 g of 2.87 M trivalent cerium nitrate, 33.9 g of 68% HNO3. This solution was put into 250 mL semi-closed vessel. Subsequently cerium nitrate (IV) equivalent with 1/5000 of cerium IV/total cerium molar ratio was added to the cerium nitrate solution. The ammonia aqueous solution was prepared by mixing 133.1 g of 15 M ammonia water, 1297.7 g of deionized water and 0.83 g of pivalic acid. This solution was put into 2 L semi-closed reactor jacketed, and bubbled by N2 gas at the flow of 100 L/h under agitation for 1 hour. The above described cerium nitrate solution was added to the ammonia aqueous solution in approximately 30 min in the same conditions of agitation and N2 bubbling. The temperature of reaction mixture was heated up to 80° C. in approximately 1 hour and maintained for approximately 4 hours at the same conditions of agitation with reduced N2 bubbling flow (below 10 L/h). The reaction mixture was cooled down and acidified at pH 2 with 68% HNO3. After decantation, the supernatant was removed and NH4OH was added to the slurry to reach pH 8.

The reaction mixture was washed with deionized water thanks to centrifugation. The 5 washing was repeated when the conductivity of washing solution was less 0.04 mS/cm.

The BET specific surface area determined by nitrogen adsorption was 23 m2/g. The suspension was observed by TEM, for approximately 150 particles representative of the suspension, each of particles were counted and measured. The average particle size was 81 nm and standard deviation was 30 nm corresponding to 37% of average particle size. The SSA size, determined as explained in the present specification, is equal to 36, giving a roughness index RI, determined as explained in the present specification, of 2.2. The percentage of Carbon is determined as % C=0.21 wt %. TEM picture of the spheroidal rough particles obtained is reported in FIG. 3.

### Example 4

A cerium nitrate solution was prepared by mixing 222.4 g of 2.87 M trivalent cerium nitrate, 33.9 g of 68% HNO3. This solution was put into 250 mL semi-closed vessel. Subsequently cerium nitrate (IV) equivalent with 1/5000 of cerium IV/total cerium molar ratio was added to the cerium nitrate solution. The ammonia aqueous solution was prepared by mixing 133.9 g of 14.9 M ammonia water, 1296.8 g of deionized water and 1.18 g of adipic acid. This solution was put into 2 L semi-closed reactor jacketed, and bubbled by N2 gas at the flow of 100 L/h under agitation for 1 hour. The above described cerium nitrate solution was added to the ammonia aqueous solution in approximately 30 min in the same conditions of agitation and N2 bubbling. The temperature of reaction mixture was heated up to 80° C. in approximately 1 hour and maintained for approximately 4 hours at the same conditions of agitation with reduced N2 bubbling flow (below 10 L/h). The reaction mixture was cooled down and acidified at pH 2 with 68% HNO3. After decantation, the supernatant was removed and NH4OH was added to the slurry to reach pH 8.

The reaction mixture was washed with deionized water thanks to centrifugation. The 5 washing was repeated when the conductivity of washing solution was less 0.04 mS/cm.

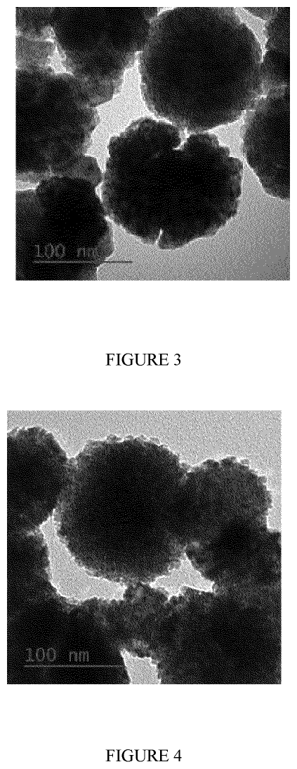

The BET specific surface area determined by nitrogen adsorption was 35 m2 /g. The suspension was observed by TEM, for approximately 220 particles representative of the suspension, each of particles were counted and measured. The average particle size was 87 nm and standard deviation was 34 nm corresponding to 39% of average particle size. The SSA size, determined as explained in the present specification, is equal to 24, giving a roughness index RI, determined as explained in the present specification, of 3.6. The percentage of Carbon is determined as % =0.61 wt %. TEM picture of the spheroidal rough particles obtained is reported in FIG. 4.

### Comparative example 1

A cerium nitrate solution was prepared by mixing 139.1 g of 2.87 M trivalent cerium nitrate, 21.1 g of 68% HNO3 and 4 g of deionized water. This solution was put into 250 mL semi-closed vessel. Subsequently cerium nitrate (IV) equivalent with 1/5000 of cerium IV/total cerium molar ratio was added to the cerium nitrate solution. The ammonia aqueous solution was prepared by mixing 100.5 g of 13.35 M ammonia water and 795.5 g of deionized water. This solution was put into 1 L semi-closed reactor jacketed, and bubbled by N2 gas at the flow of 210 L/h under agitation for 1 hour. The above described cerium nitrate solution was added to the ammonia aqueous solution in approximately 30 min in the same conditions of agitation and N2 bubbling. The temperature of reaction mixture was heated up to 85° C. in approximately 1 hours and maintained for approximately 4 hours at the same conditions of agitation with reduced N2 bubbling flow (below 10 L/h). The reaction mixture was cooled down and acidified at pH 2 with 68% HNO3. After decantation, the supernatant was removed and NH4OH was added to the slurry to reach pH 8.

The reaction mixture was washed with deionized water thanks to centrifugation. The washing was repeated when the conductivity of washing solution was less 0.04 mS/cm.

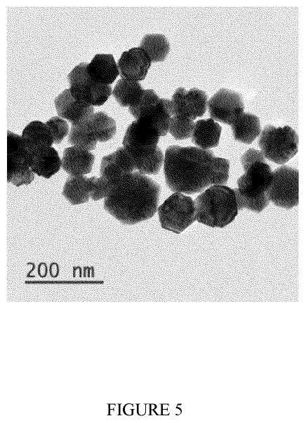

The BET specific surface area determined by nitrogen adsorption was 16.8 m2 /g. The suspension was observed by TEM, for approximately 150 particles representative of the suspension, each of particles were counted and measured. The average particle size was 87 nm and standard deviation was 21 nm corresponding to 24% of average particle size. The SSA size, determined as explained in the present specification, is equal to 50, giving a roughness index RI, determined as explained in the present specification, of 1.7. TEM picture is reported in FIG. 5.

1. A process for producing cerium oxide particles, comprising the following steps:
(a) contacting, under an inert atmosphere, (i) an aqueous solution of a base, (ii) an aqueous solution comprising NO₃⁻, Ce^{III}, optionally CO^{IV}, and (iii) an organic acid or a salt thereof to obtain a mixture, wherein the organic acid is a substituted or unsubstituted, C1-C20 -alkyl, -alkenyl or -alkynyl carboxylic acid;
(b) subjecting the mixture obtained in step (a) to a thermal treatment carried out at a temperature ranging from 75° C. to 95° C.;
(c) optionally acidifying the mixture obtained in step (b);
(d) optionally washing with water the solid material obtained at the end of step (b) or (c);
(e) optionally subjecting the solid material obtained at the end of step (d) to a mechanical treatment to deagglomerate the particles.

2. The process according to claim 1, wherein the organic acid is a substituted or unsubstituted C1-C12 alkyl carboxylic acid.

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. Cerium oxide particles characterized in that said particles are spheroidal in shape and exhibit a roughness index RI of at least 2, wherein RI is defined by the formula:
$$RI = \frac{TEM size}{SSA size}$$
wherein “TEM size” denotes the average size of the particles measured on transmission electron microscopy images from at least 80 particles and “SSA size” denotes the theoretical average size of the particles according to the following formula:
$$SSA size = \frac{6}{SSA \times ρ}$$
wherein SSA denotes the BET specific surface area of the particles determined by nitrogen adsorption and ρ denotes the density of cerium(IV) oxide and is equal to 7.22 g/cm³ and in that said particles exhibit a carbon weight ratio ranging from 0.001 wt % to 5 wt %, in particular from 0.1 wt % to 2.5 wt %.

19. The cerium oxide particles according to claim 18, characterized in that said particles exhibit a sphericity ratio SR between 0.8 and 1.0 wherein SR is calculated from the measured perimeter P and area A of the particles projection using the following equation:
$$SR = 4 π \frac{A}{{P}^{2}}$$
and determined by a Dynamic Image Analysis (DIA), notably pursuant to ISO 13322-2 (2006).

20. (canceled)

21. (canceled)

22. The cerium oxide particles according to claim 18, characterized in that said particles exhibit a specific surface area comprised between 15 and 100 m²/g.

23. The cerium oxide particles according to claim 22 characterized in that said particles exhibit a specific surface area comprised between 20 and 40 m²/g.

24. The cerium oxide particles according to claim 18, characterized in that said particles exhibit an average size from 30 to 500 nm, said average size being measured from TEM images.

25. The cerium oxide particles according to claim 24 characterized in that said particles exhibit an average size which is comprised between 140 and 300 nm.

26. The cerium oxide particles according to any one of claim 18, which are obtained by the process according to comprising the following steps:
(a) contacting, under an inert atmosphere, (i) an aqueous solution of a base, (ii) an aqueous solution comprising NO₃⁻, Ce^{III}, optionally Ce^{IV}, and (iii) an organic acid or a salt thereof to obtain a mixture, wherein the organic acid is a substituted or unsubstituted, C1-C20 -alkyl, -alkenyl or -alkynyl carboxylic acid;
(b) subjecting the mixture obtained in step (a) to a thermal treatment carried out at a temperature ranging from 75° C. to 95° C.;
(c) optionally acidifying the mixture obtained in step (b);
(d) optionally washing with water the solid material obtained at the end of step (b) or (c);
(e) optionally subjecting the solid material obtained at the end of step (d) to a mechanical treatment to deagglomerate the particles.

27. A dispersion of cerium oxide particles according to of claim 18 in a liquid medium.

28. A method of preparing a polishing composition the method comprising the addition of different ingredients other than the cerium oxide particles of claim 26 or a dispersion of the cerium oxide particles in a liquid medium.

29. A polishing composition comprising the cerium oxide particles characterized in that said particles exhibit a sphericity ratio SR between 0.8 and 1.0, wherein SR is calculated from the measured perimeter P and area A of the particles projection using the following equation:
$$SR = 4 π \frac{A}{{P}^{2}}$$
and determined by a Dynamic Image Analysis (DIA), notably pursuant to ISO 13322-2 (2006) or the dispersion of claim 27.

30. A method for removing a portion of a substrate, comprising polishing the substrate with a polishing composition according to claim 29.

31. The cerium oxide particles according to claim 18, characterized in that said roughness index RI is of at least 3.5.

32. The cerium oxide particles according to claim 18, characterized in that said particles exhibit a carbon weight ratio ranging from 0.1 wt % to 2.5 wt %.
